(19) United States
(12) Patent Application Publication
(10) Pub. No.: US 2004/0156421 A1
(43) Pub. Date: Aug. 12, 2004

(54) Coding and receiver structure for ultra wide band communications

(76) Inventor: Hirohisa Yamaguchi, Ibaraki (JP)

Correspondence Address: TEXAS INSTRUMENTS INCORPORATED, P O BOX 655474, M/S 3999, DALLAS, TX, 75265

(21) Appl. No.: 10/361,656

(22) Filed: Feb. 10, 2003

(51) Int. Cl. H04B 1/69

(52) U.S. Cl. 375/130

(57) ABSTRACT

The ultra wide band communication system of the present invention includes a transmitter (station) and a receiver (station). The transmitter employs correlated spreading code such that consecutive information bits are spread with differing code. The receiver includes an analog circuit filter comprised of a cascade of unit components that appropriately de-spread and accumulate a received signal to obtain a transmitted signal without substantial hardware complexity. The unit components are substantially comprised of analog components including, a sample and hold circuit, a leaky integrator, and a multiplier.

### FIELD OF THE INVENTION

The present invention relates generally to the field of wireless communication, and more particularly, relates to systems and methods that facilitate ultra wide band communications.

### BACKGROUND OF THE INVENTION

The desire for wireless communication and faster communication speeds are considerable and ever increasing. As time goes on, more and more devices from portable computers and portable digital assistants to cellular phones are utilizing and demanding more communication speed and bandwidth. In addition to the number of devices, the amount of data being transferred via wireless communication is also increasing because of the types of data being sent. Communications have advanced from merely transporting voice data to transporting multimedia information, including graphical and video information, which employ greater amounts of information.

One particular type of wireless communication is ultra wide band communication (UWB), which operates at about the 3.1-10.6 GHz range and relies on the principle that a high data-rate communication is achievable at a small transmission power when signal bandwidth is appreciably large. As a result, UWB promises to permit high data rates for less power than at least some conventional wireless communication systems. This characteristic can permit devices to transfer more data while operating with less power, which could extend battery life of devices (e.g., cellular phones, laptop computers, and the like) along with other benefits. Additionally, UWB communication is at such a relatively low power that it can mitigate interference with other types of communication. For example, a UWB transmission could appear as merely white noise to a conventional receiver.

One potential problem or difficulty that can be encountered with substantially all wireless communication technologies, and particularly UWB, is that of multipath signals. Multipath signals are generated when a transmitter sends or broadcasts a signal, generally in all directions, and a number of copies of that signal are received at a receiver. Signals often do not travel in a straight line from a transmitter to a receiver (line of sight), but can often bounce off objects so as to end up at the receiver. The copies occur because the original signal bounces against objects during transmission resulting in the number of copies arriving at the receiver, generally with varying delays. Multipath signals can cause a receiver to misinterpret the information being transmitted and/or introduce erroneous information into communication.

### SUMMARY OF THE INVENTION

The following presents a simplified summary in order to provide a basic understanding of one or more aspects of the invention. This summary is not an extensive overview of the invention, and is neither intended to identify key or critical elements of the invention, nor to delineate the scope thereof. Rather, the primary purpose of the summary is to present some concepts of the invention in a simplified form as a prelude to the more detailed description that is presented later.

The present invention provides a communication system that facilitates ultra wide band high data rate wireless communication. The system achieves suitable data rate performance (e.g., 100 Mbps) by suitably resolving multipaths without substantial hardware complexity. Thus, the system can be implemented with relatively high-performance and a relatively low cost.

The ultra wide band communication system of the present invention includes a transmitter (station) and a receiver (station). The transmitter employs correlated spreading code such that consecutive information bits are spread with differing code. The receiver includes an analog circuit filter comprised of a cascade of unit components that appropriately de-spread and accumulate a received signal to obtain a transmitted signal without substantial hardware complexity. The unit components are substantially comprised of analog components including, a sample and hold circuit, a leaky integrator, and a multiplier.

To the accomplishment of the foregoing and related ends, the invention comprises the features hereinafter fully described and particularly pointed out in the claims. The following description and the annexed drawings set forth in detail certain illustrative aspects and implementations of the invention. These are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF THE DRAWINGS

FIG. 1 is block diagram illustrating an ultra wide band communication system in accordance with an aspect of the present invention.

FIG. 2 is a diagram illustrating generation of multipath signals.

FIG. 3 is a block diagram illustrating a receiver in accordance with an aspect of the present invention.

FIG. 4 is a schematic diagram illustrating an exemplary low-frequency circuit representation of a unit component in accordance with an aspect of the present invention.

FIG. 5 is a diagram illustrating an exemplary single information bit spread into a group of impulse signals.

FIG. 6 is a diagram illustrating exemplary signals for a wireless communication system.

FIG. 7 is a diagram illustrating an exemplary spreading code sequence generator.

FIG. 8 is a diagram illustrating an exemplary transmitted code spread signal in accordance with an aspect of the present invention.

FIG. 9 is a graph illustrating a first simulation of a communication employing constant spreading code for successive information bits.

FIG. 10 is a graph illustrating a second simulation of a communication employing varied spreading code for successive information bits.

FIG. 11 is a block diagram illustrating an exemplary CDMA system.

FIG. 12 is a flow diagram illustrating a method of resolving a received signal in accordance with an aspect of the present invention.

FIG. 13 is a flow diagram illustrating a method of communicating via ultra wide band communication in accordance with an aspect of the present invention.

### DETAILED DESCRIPTION OF THE INVENTION

The present invention will now be described with respect to the accompanying drawings in which like numbered elements represent like parts. The figures provided herewith and the accompanying description of the figures are merely provided for illustrative purposes. One of ordinary skill in the art should realize, based on the instant description, other implementations and methods for fabricating the devices and structures illustrated in the figures and in the following description.

The present invention facilitates high rate data communication at relatively low transmission power for ultra wide band communication (UWB) systems. UWB systems operate at about the 3.1-10.6 GHz range and rely on the principle that a high data-rate communication is achievable at a small transmission power when signal bandwidth is appreciably large. The present invention can be employed to provide and/or facilitate wireless local area networks, cellular type wireless communication, positioning systems, and the like. Additionally, the present invention suitably resolves multipath signals without substantial hardware complexity, thereby permitting a high-performance system to be implemented with a relatively low cost.

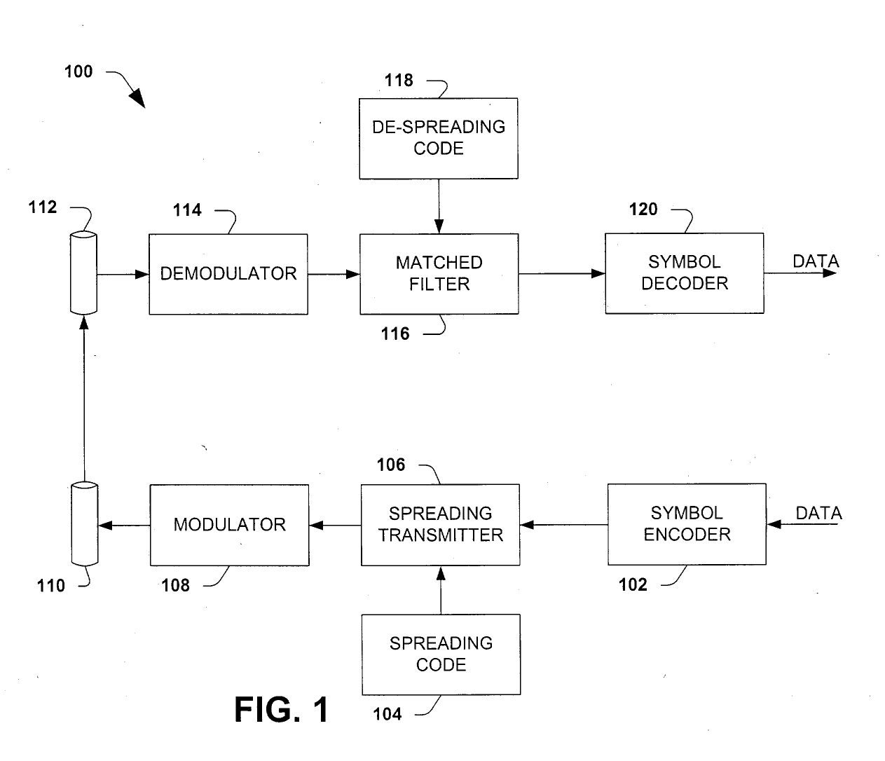

Beginning with FIG. 1, an ultra wide band (UWB) communication system 100 in accordance with an aspect of the present invention is disclosed. The system 100 is operable to transmit and receive information/data at high data rates (e.g., 100 Mbps) with relatively low power. The data rate is partly distance-dependent. For example, 100 to 110 Mbps is possible for line-of-sight transmissions greater than about 10 meters. Even higher data rates are possible (e.g., 400 Mbps) for transmission paths that are less than or equal to about 5 meters.

The system 100 includes a transceiver or transmitter station for sending information and signals and a receiver or receiver station for receiving signals and information. For illustrative purposes, the system 100 is described with respect to a single transmitter station and a single receiver station, however the present invention can include additional transmitter stations and receiver stations and still be in accordance with the present invention. Additionally, transmitter station(s) and receiver station(s) can be on one device (e.g., a computer system) and be in accordance with the present invention.

The system 100 shows the general system structure of the CDMA communication system in which spreading code is used to share the same bandwidth by multiple users or all users of the system 100. Respective users (receiver stations) have filters that identify and obtain information intended for them and are not generally able to obtain information not intended for them. The system 100 is operable to broadcast or transmit information such that more than one receiver station is able to obtain the transmitted information and still is in accordance with the present invention. This basic concept can be extended for the UWB communication even under severe multipath conditions.

Starting with the transmitter station (e.g., also referred to as base station, mobile station, transceiver, and the like), a symbol encoder 102 receives some information or data and encodes the information into an original, digital signal. The information received can be about any type of data or information represent-able electronically. For example, the information could be a portion of a data file, multimedia information, database information, and the like. For another example, the information could be analog voice data for voice communication. The encoded information, the original signal, can be a compressed and/or encrypted representation of the original information.

A spreading transmitter 106 receives the signal from the symbol encoder 102. The spreading transmitter 106 utilizes a spreading code 104 to spread each information bit of the original signal into a number (e.g., several dozens) of small power impulse signals under a spectrum mark constant. Thus, the spreading transmitter 106 spreads the original signal according to the spreading code, which can be a sequence of numbers such as −1 and +1 or a sequence of complex numbers (1+j)/sqrt(2), 1−j)/sqrt(2), and the like. The spreading code can be any suitable code that has a good auto-correlation property (i.e., the pattern matching results 1 for the matched position and 0 for the rest). In practice, residual matching noise can exist. Some particular spreading codes, such as Gold codes, are known to have the good auto-correlation property and have been adopted in the third-generation (3D) digital cellular systems.

Generally, each information bit is spread with a code, which results in a number of impulse signals, referred to as code spread impulse signals. The spreading code includes a code group of varied, correlated codes such that successive information bits are coded with varied codes.

A modulator 108 receives the original signal, now spread, from the spreading transmitter and modulates the signal from a base-band to an ultra wide band frequency suitable for transmission. Additionally, the modulator 108 performs a digital to analog conversion on the original signal prior to modulation. A transceiver device 110 transmits or broadcasts the modulated original signal in a plurality of directions.

At a receiver station, a receiving device 112 (e.g., an antenna or multiple antennas) receives a signal. The received signal is generally a composite of one or more signals, which can include one or more multipath signals. Multipath signals are versions or copies of the transmitted signal that followed varied transmission paths. An additional description of multipath signals is provided infra. The one or more signals of the received signal can also include other unknown/undesired signals, unintended signals (e.g., signals intended for another receiver station) and/or noise. A demodulator 114 takes the received signal and demodulates the received signal from an ultra wide band frequency to a base-band. By so doing, some noise and/or unwanted signals can be removed from the received signal. Additionally, the demodulator 114 typically performs an analog to digital conversion on the received signal.

A de-spreader filter 116 receives the signal from the demodulator 114 and filters and removes unwanted and duplicate signals to obtain the original signal previously sent from the transmitter 110. The matched filter 114 employs a de-spreading code 118 that corresponds or is identical to the spreading code employed in transmission. The matched filter 114 employs the de-spreading code along with cascaded units described infra in order to substantially obtain the original signal from the received signal. By so doing, the matched filter 114 performs delay-profile measurements concurrently with de-spreading of the received signal. Additionally, the de-spreader filter 116 is configurable to specific delay profiles, such as an indoor delay profile.

Depending on the room size, the indoor path delay time has been measured to lie in the 30 to 100 nsec range. This is additional delay after the earliest wave reaches at the receiver, and corresponds to the reflections from the walls and the floor. In the line-of-sight case, the earliest arrival time is exactly the distance divided by the speed of light.

A symbol decoder 120 operates on the original signal to decode and/or decrypt the original signal to obtain the original information/data, which can then be processed by a higher layer (e.g., error correction, decryption, decompression, and the like) and/or utilized. The original information can then be used, for example, by a computer, personal digital assistant, cellular phone, or other electronic device.

It is appreciated that one or both of the transmitter station and the receiver station are mobile devices (e.g., cellular phones, laptop computers, personal digital assistants, positioning systems, and the like). Additionally, as stated above, the system 100 can include multiple transmitter stations and receiver stations. Furthermore, a single device can have both a transmitter station and a receiver station to permit full duplex communication.

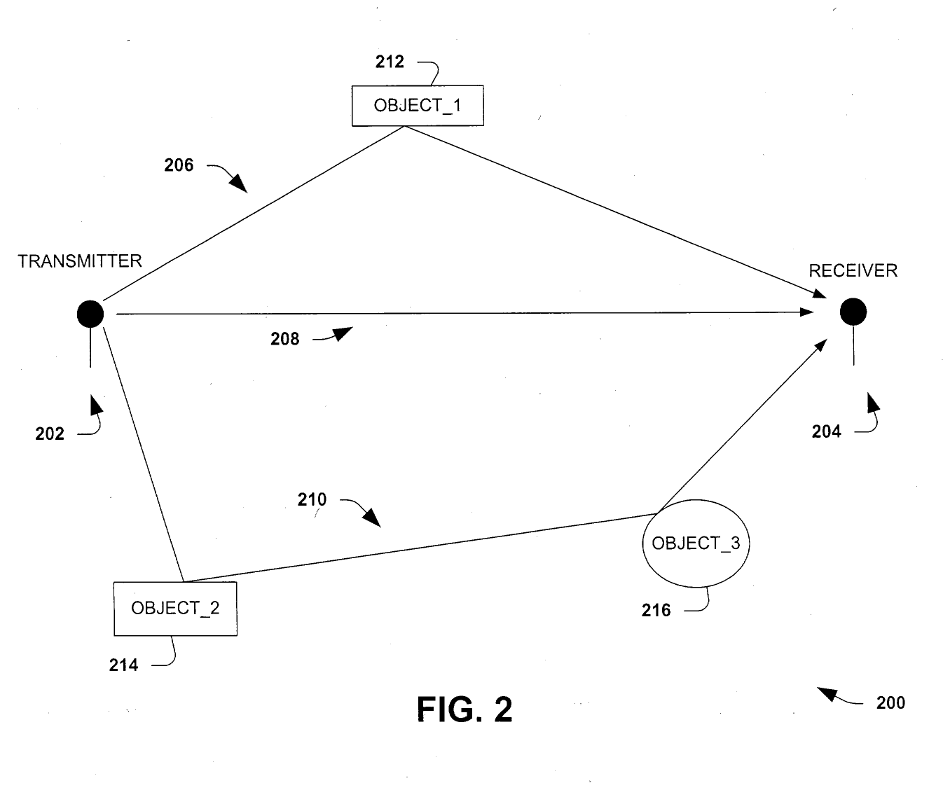

Turning now to FIG. 2, a diagram illustrating generation of multipath signals is shown. The diagram is exemplary in nature and provided merely for the purposes of illustrating multipath signals and is not intended to limit and/or restrict the present invention to a particular operating environment or number of multipath signals.

The generated signals shown follow transmission paths from a transmitter 202 to a receiver 204, which are in accordance with the present invention. The transmitter 202 is operable to send or broadcast a signal in many directions. Here, a first signal 206, a second signal 208, and a third signal 210 are depicted as being transmitted. Initially, the signals are substantially identical, but each of the signals follows a different transmission path, also referred to as path of propagation. The first signal 206 bounces off a first object 212 and continues along to the receiver 204. The second signal 208 follows a straight line or line of sight path from the transmitter 202 to the receiver 204. The third signal 210 bounces off a second object 214 and a third object 216 before arriving at the receiver 204. As a result, the first signal 206, the second signal 208, and the third signal 210 can arrive at the receiver at varied times with varied power because of the variations in path length, propagation mediums and the like. Because of the present invention as discussed herein, the receiver 204 is able to obtain a substantially true or original signal from the multiple signals received.

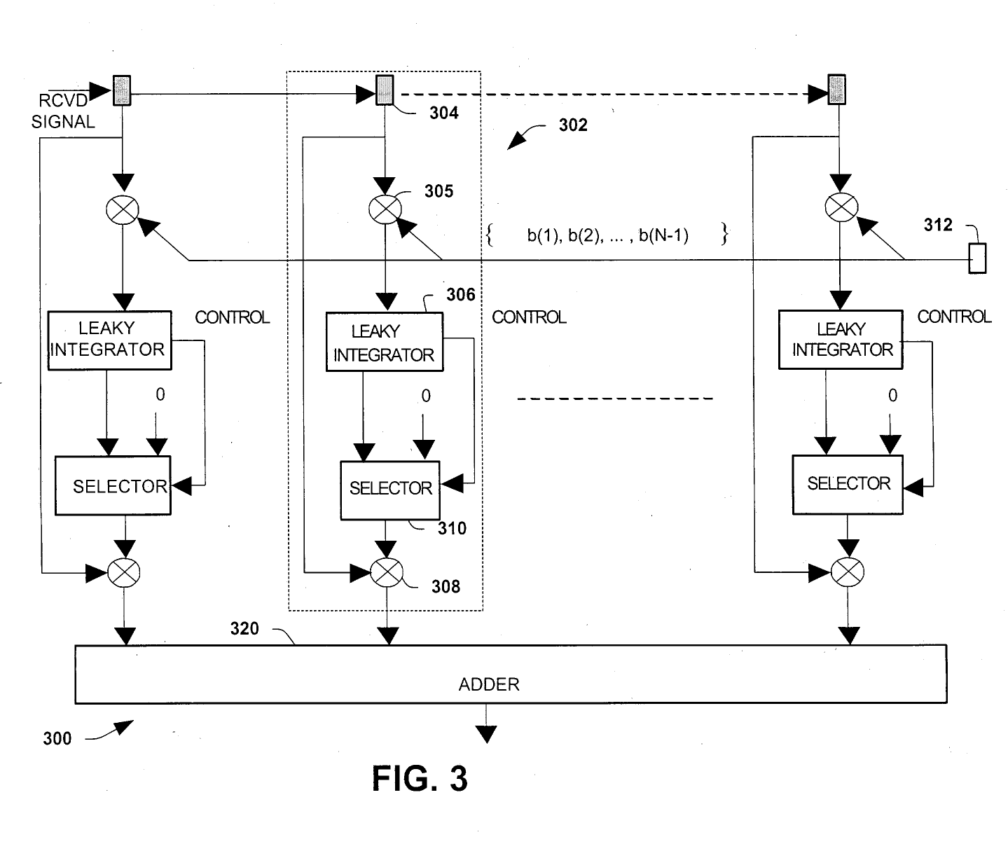

FIG. 3 is a diagram depicting a receiver 300 in accordance with an aspect of the present invention. The receiver 300 facilitates high data-rates (e.g., 100 Mbps) in ultra wide band communications while mitigating difficulties from multipath signals and/or multipath environments (e.g., indoor environments). The receiver 300 combines delay-profile measurements and a de-spreading function together in a way to circumvent difficulties in timing adjustment and ratio combining (e.g., maximum ratio-combining) as discussed infra. Conventional receivers are unable to feasibly combine delay-profile measurements and de-spreading functions to overcome the aforementioned difficulties for ultra wide band communication systems.

The receiver 300 is comprised of a number of cascaded unit components 302. Respective unit components comprise a sample and hold circuit 304, a spread code multiplier 305, a leaky integrator 306, a multiplier 308, and a selector 310. Additionally, the receiver further comprises an adder 320 that sums the outputs from the multiplier 308 of respective unit components.

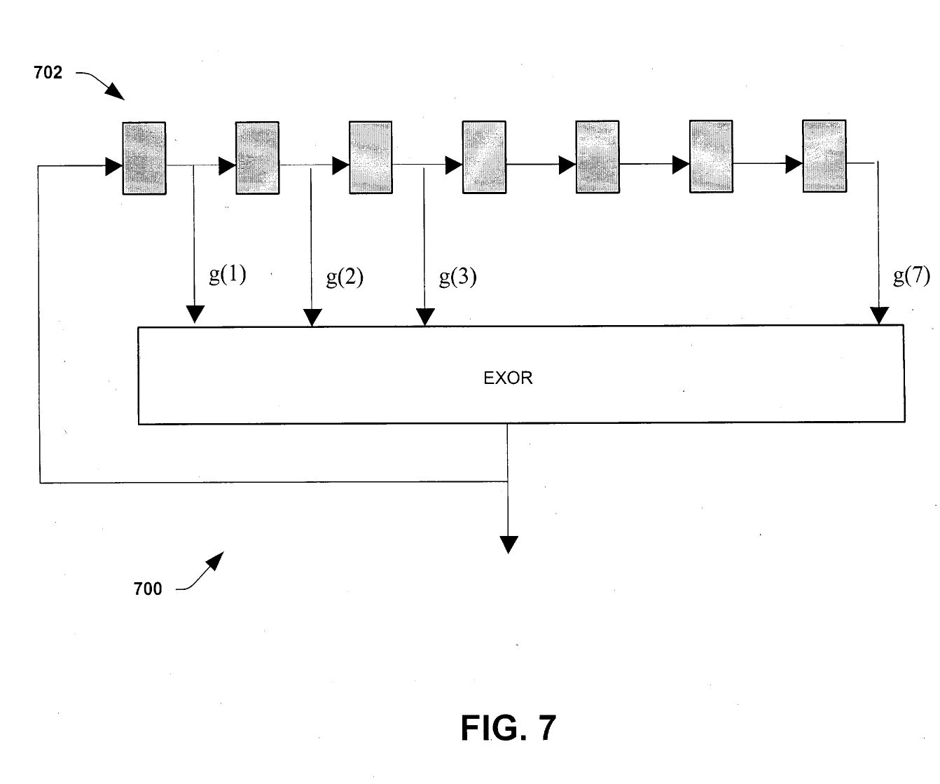

A received signal is input into the sample and hold circuit 304 (e.g., from a previous unit component). The received signal is “held” or stored in the sample and hold circuit 304 for a clock cycle (not shown) and then concurrently sent to a next unit component while receiving a next received signal from the previous unit component. An output of the sample and hold circuit 304 is multiplied with spreading code (sign only and the spreading code is common with all of the unit components 302) by the spread multiplier 305, the result of which is then input into the leaky integrator 306. The spreading code can also be referred to as de-spreading code and is correlated to spreading code employed at a transmitter station (e.g., spreading transmitter 106 of FIG. 1). The spreading code is provided to the spread multiplier 305 by a code generation circuit 312. FIG. 7, described infra, is an example of a code generation circuit.

The leaky integrator 306 continuously accumulates a channel delay profile irrespective of a spreading code boundary or code group described infra. The leaky integrator 306 has a leak-time constant of a specified duration (e.g., several milliseconds for practical applications) that matches an indoor delay profile. The indoor delay profile is a delay profile for an indoor environment, which typically has “early” reflections with little power loss resulting in a profile that is initially flat with a tail of weaker reflections or multipath signals. A delay profile is an expected power per unit of time according to a certain delay. It is appreciated by the present invention that the indoor delay profile can vary for different environments (e.g., urban or rural) and that the present invention is operable and/or adaptable for use with other types of delay profiles.

An output of the leaky integrator 306, referred to as the channel estimate, is selectively multiplied with the input to the leaky integrator 306 by the multiplier 308. A selector 310 can selectively replace the channel estimate with a zero value according to a magnitude of the channel estimate accumulated by the leaky integrator 306 thereby causing the multiplier 308 to output a zero or off value. When the magnitude of the accumulated channel estimate is less than a threshold amount, the multiplier 308 is effectively turned off and, therefore, outputs a zero or off signal. The threshold amount is determined and/or set according to a specific delay profile and/or indoor delay profile. The selector 310 is controlled via the leaky integrator 306 to select whether the output of the leaky integrator or zero is sent to the multiplier 308.

Subsequently, the adder 320 sums outputs from the multiplier 308 of respective unit components 302. Because of the operation of the leaky integrator 306 and the selector 310, only the de-spread outputs exceeding the threshold value discussed supra are summed. Those units that do not exceed the threshold amount output zero or are off and do not contribute to the sum derived by the adder 320. The result from the adder 320 is substantially identical to that of a maximum ratio combiner, discussed infra, and can then be transferred to a higher level processing block (e.g., error correction).

The number of unit components 302 is a function of the largest delay considered for the receiver 300. As an example, for a 100 nsec maximum delay and a 250 psec UWB impulse signal, which are values that correspond to about a 100 Mbps data rate in an indoor environment, the number of unit components is about 400. This results in reasonable and modest hardware complexity. As another example, for a 30 nsec maximum delay, a 500 psec UWB impulse signal is used. For this example, the number of unit components is reduced to about 60.

Over-sampling of the received signal can optionally be performed to facilitate receiver performance and still be in accordance with the present invention.

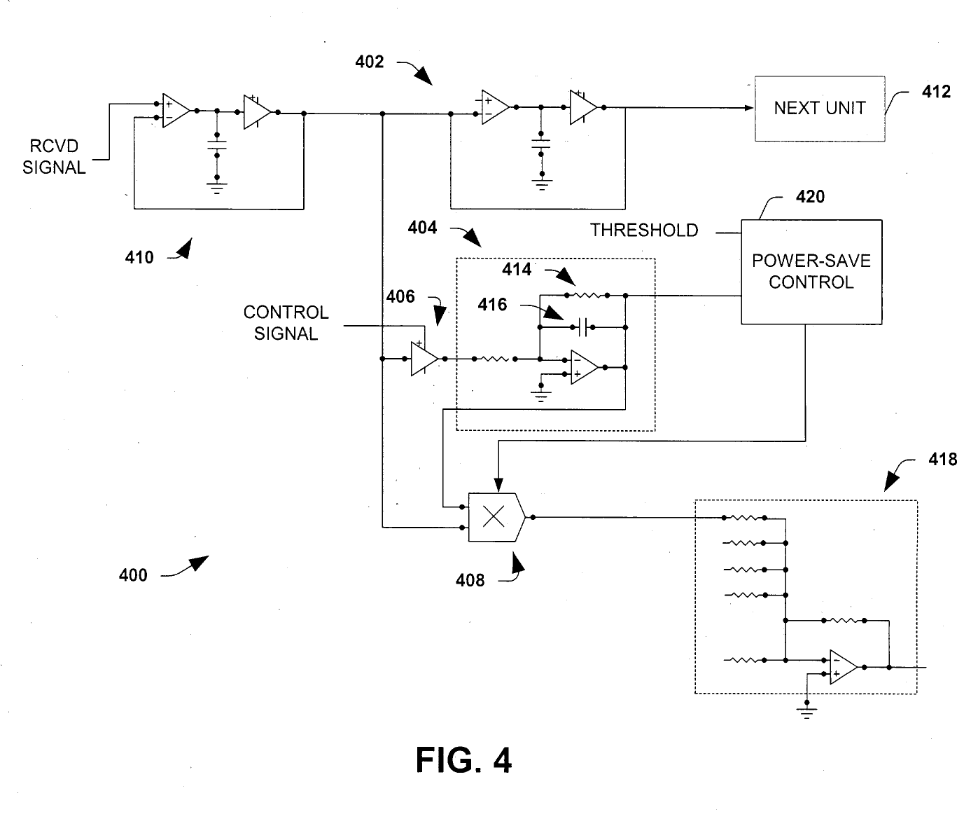

FIG. 4 is a schematic diagram depicting an exemplary equivalent low-frequency circuit representation of a unit component 400 in accordance with an aspect of the present invention. For strictly explanatory and illustrative purposes, a general operational amplifier and buffer amplifier are employed to illustrate the schematic.

The unit component 400 comprises a sample and hold circuit 402, a leaky integrator 404 with an externally controllable inverter 406, and a multiplier 408. The sample and hold circuit 402 receives an input signal from a previous sample and hold unit 410 and maintains a signal value while the value is transferred to a next unit component 412. (FIG. 4 does not show a transfer clock signal for illustrative purposes only).

The input signal is received by the controllable inverter 406 (an adaptively switched inverted/non-inverted amp), which is controlled by a control signal that is concurrently applied to substantially all the unit components of the receiver in parallel. The control signal is a de-spreading code sequence. The inverter 406 controllably and selectively inverts the input signal, which is then received by the leaky integrator circuit 404. The leaky integrator circuit 404 performs channel estimation on the input signal. The leaky integrator circuit 404 has a leak time constant that can be adjusted or set by a resistor 414 and/or capacitor 416. The output of the leaky integrator 404 is a signed magnitude of a channel response observed at the receiver (delay profile corresponding to the signal input timing of the respective unit component). The output of the leaky integrator 404 is multiplied with the input signal by the multiplier 408. The multiplier 408 is turned off or shut down (no VCC supply) by a power-save component 420 when the integrator 404 output magnitude is below a threshold value. This threshold value determines the significant level of the multipath signals that are (maximum) ratio combined. When the magnitude level is below this threshold and the multiplier 408 is off, the multiplier 408 outputs a zero or off. The time required for turning off of the multiplier 408 is relatively slow (e.g., several milliseconds) due to the slow change speed of the indoor channel profile. The threshold value can be a common value for all unit components or can vary by unit (e.g., independently adjustable in order to level out variations of analog circuit parameters). An output of the multiplier 408 is summed together with outputs from other multipliers of other unit components, generally with equal weight, by an adding circuit 418.

It is appreciated that the accuracy of this unit component 400 is based on the accuracy of signals transferred between the various amplifiers and multipliers. Additionally, it is appreciated that a suitable test signal could be employed to adjust or tune receiver performance before a system or product employing the receiver is shipped or delivered.

It is appreciated by the inventor of the present invention that communications systems can employ code-modulation using orthogonal codes (e.g., CDMA cellular systems) to spread information bits respectively into several (e.g., dozens) small power impulse signals under a spectrum mark constraint. Then, at the receiver, multi-path signals are resolved by applying spreading code (or de-spreading code) by a matched filter. Each resolved path signal is then individually de-spread by a single path match filter component also referred to as a finger. The de-spreading code is synchronized and/or corresponds to spreading code generated and employed by the transmitter. The resulting information is employed to set fingers (a resolved, de-spread signal) at each path delay time, and each path signal is de-spread.

The de-spread signals are summed by a maximum ratio combiner, which adds the received signals with weight equal to the average signal amplitude. This combining of the received signals can improve signal to noise ratio and mitigate errors.

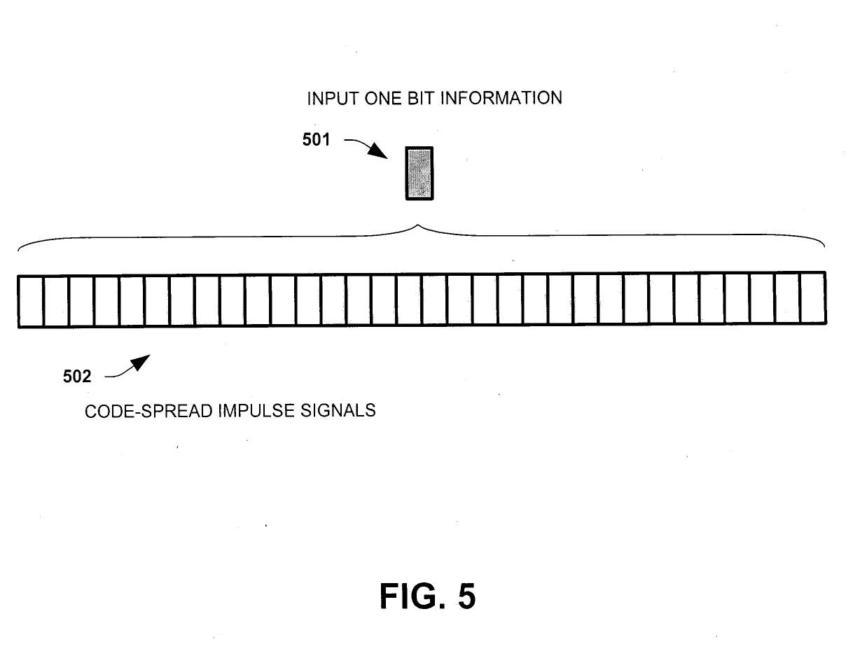

FIG. 5 illustrates a single information bit that is spread and transmitted by a transmitter as a group of impulse signals 502, referred to as code-spread impulse signals. It is appreciated that for ultra wide band communication systems, a single information bit is spread over about more than 40 impulse signals and about less than 200 impulse signals.

For example, when 100 Mbps of information is transmitted over a bandwidth of 4 GHz, each impulse is 250 psec in duration and 4 G impulse signals can be transmitted per second. Thus 40 impulse signals are assigned to each bit (4 G/100, M=40). When 20 Mbps are transmitted (at a larger distance), 4 G/20 M=200 impulses are assigned to each one bit. The UWB system can flexibly assign the number of impulses to each one bit of the transmitted information depending on distance, desired data rate and channel condition.

It is appreciated that such large numbers of impulse signals fro a single information bit can generate large numbers of multipath signals, which have been described supra.

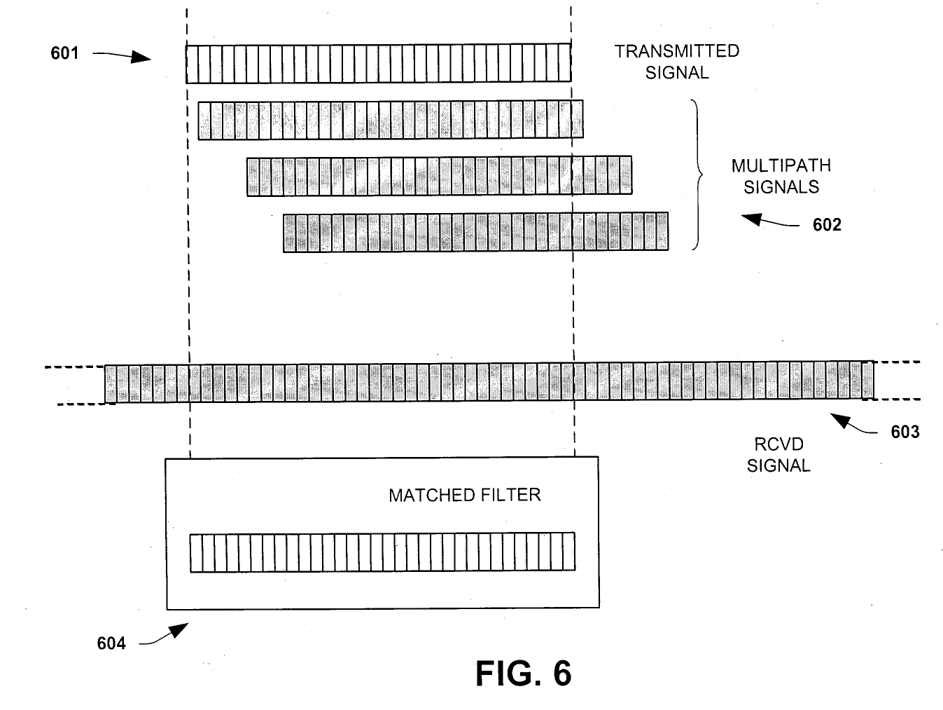

FIG. 6 illustrates exemplary signals for an ultra wide band wireless communication system. A transmitted signal 601, comprised of a group of code-spread impulse signals, generates a number of multipath signals 602 as a result of objects interfering and/or altering transmission paths. As a result, a receiver receives a received signal 603 comprised of the transmitted signal 601 along with the multipath signals 602. In order for the receiver to obtain the transmitted signal, the received signal 603 needs to be resolved. The received signal 603 can be resolved if the transmitted signal possesses a specific auto correlation property. One suitable correlation or spreading code sequence is {b(n)} n=1, . . . N generated as an M-sequence with the following characteristic:

$${\sum }_{n = 0}^{N - 1} b ( n ) b ( n - k ) = 1 ( k = 0 ) \\ = - \frac{1}{N} ( else ) . \qquad ( 1 )$$

Where N is the number of impulse signals allocated to each information bit, and it is also the repetition cycle of the M-sequence and b(n) are spreading factors. FIG. 7 depicts an exemplary suitable M-sequence generating circuit 700 that employs a plurality of shift registers 702. The circuit 700 generates codes of 127 bit cycles. A ‘0’ bit is added at the end of each 127 bit cycle in order to complete a 128 bit sequence. The spreading factors correspond to multipath delay.

A typical exemplary ultra wide band wireless communication employs an impulse duration of about 250 psec and achieves or attempts to achieve an information data rate of 100 Mbps (mega bits per second). For this impulse duration, the maximum number of transmitted non-overlapping impulse signals is about 4×10⁹ (4 G signals per second). In order to achieve the desired information data rate of 100 Mbps (mega bits per second), the number of code-spread impulse signals or spreading factor assigned to each information bit is about 40. The code-spread impulse signals are spread with a single or constant spreading code. As a result, a group of impulse signals for an information bit requires a 10 nsec duration for the group of impulse signals (250 psec×40 impulse signals). For a typical indoor environment, typical signal delays extend to about 100 to 150 nsec. A typical, conventional matched filter needs to be locked to the de-spreading of one particular code during this period. Therefore, it is not possible to spread the consecutive information bits using the same spreading code and achieve the desired 100 Mbps information data rate.

However, groups of spreading codes can be employed for spreading the group of impulse signals for each information bit instead of a single spreading code. Unlike the above example, subsequent information bits are code-spread using different spreading codes with sufficient auto-correlation properties (e.g., Gold codes, which are auto-correlating spreading codes). In order to achieve the desired information data rate of 100 Mbps, an impulse transmission rate is about 4×10⁹ (4 G signals per second) and a code-spread group of 32 impulse signals per information bit.

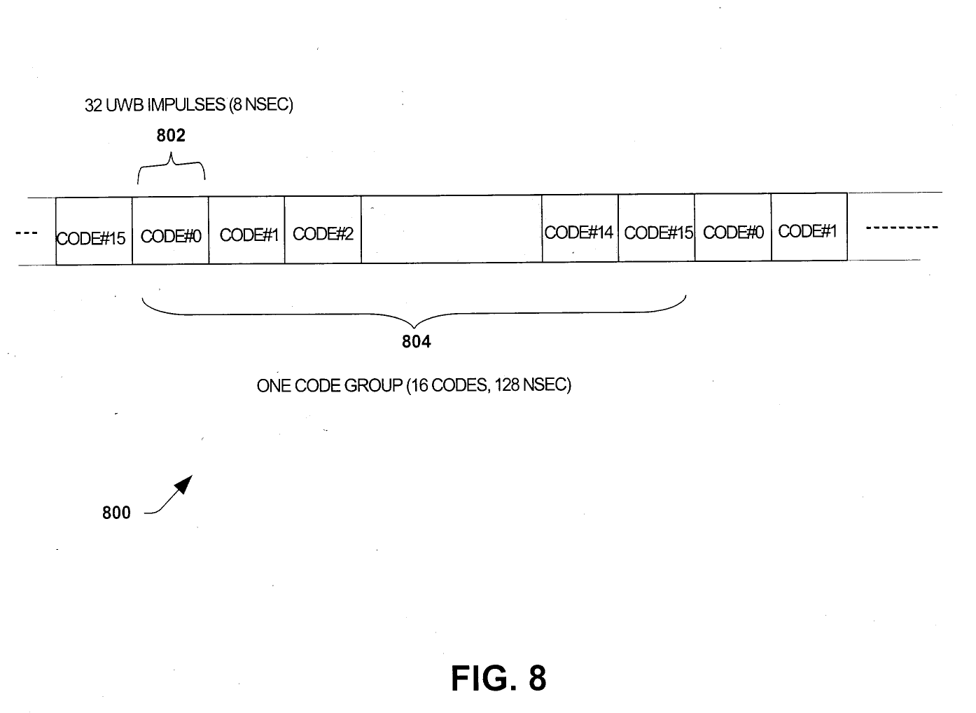

FIG. 8 illustrates an exemplary transmitted code spread signal 800. A code group 804 is comprised of 16 codes and has a duration of 128 nsec. Each code of the code group 804 is used for 32 ultra wide band impulses (N=32) and has a duration of 8 nsec. With N=32 as shown in FIG. 8, there exist 32+2 different gold codes with the desired property. For this example, 16 gold codes have been selected for FIG. 8. This exemplary transmitted code spread signal 800 permits a maximum path delay of up to 128 nsec (32 impulse signals×16 codes×250 psec (impulse duration)), which is suitable for typical indoor environments.

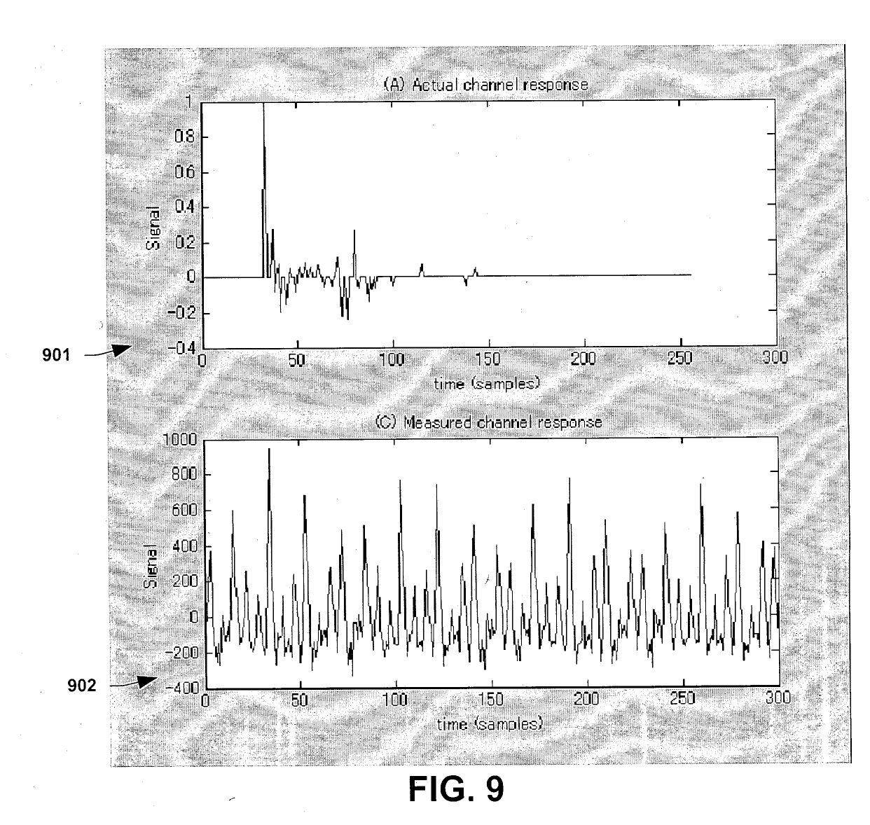

FIG. 9 depicts a first simulation of a communication employing the code structure of FIG. 5 (i.e., constant spreading code). An x-axis of FIG. 9 represents time (samples) and a y-axis represents signal strength. Plot 901 simulates a transmitted signal, also referred to as an actual channel response and plot 902 simulates a measured channel response. The simulation assumes a residential environment, non-line-of-sight (NLOS) transmission paths, and a communication distance of about 4.4 meters. A sample time of 250 psec is used, which results in a duration of about 25 nsec for 100 sample times. As a result, one information bit is spread over 32 impulse signals and has a duration of about 8 nsec. The transmitted signal of plot 901 includes a largest-power path at the 20^{th} sample time (within the spreading-code duration of 32 sample time) and two delayed paths that occur at the 50^{th} sample time and the 77^{th} sample time.

As stated above, plot 902 depicts a measured channel response (e.g., received and processed via a matched filter at a receiver station) in which a single spreading code is used to code-spread the information bits. Due to the limitations of the single spreading code for all of the information bits, the matched filter is unable to resolve the received signal and substantially obtain the original transmitted signal. The single spreading code does not permit the matched filter to resolve multipath signals and the like in order to substantially obtain the original transmitted signal.

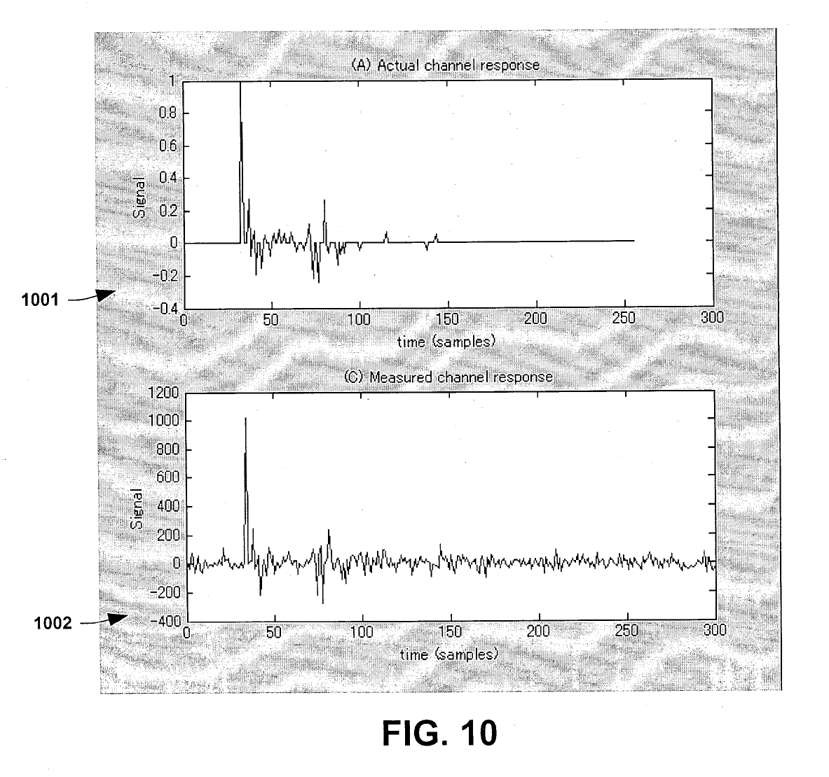

FIG. 10 depicts a second simulation of a communication/transmission employing the code structure of FIG. 8. An x-axis of FIG. 10 represents time (samples) and a y-axis represents signal strength. Plot 1001 simulates a transmitted signal, also referred to as an actual channel response and plot 1002 simulates a measured channel response. The simulation also assumes a residential environment, non-line-of-sight (NLOS) transmission paths, and a communication distance of about 4.4 meters. A sample time of 250 psec is used, which results in a duration of about 25 nsec for 100 sample times. As a result, one information bit is spread over 32 impulse signals and has a duration of about 8 nsec. The transmitted signal of plot 1001 includes a largest-power path at the 20^{th} sample time (within the spreading-code duration of 32 sample time) and two delayed paths that occur at the 50^{th} sample time and the 77^{th} sample time.

As stated above, plot 1002 depicts a measured channel response (e.g., received and processed via a matched filter at a receiver station) in which auto-correlated (e.g., Gold codes) are used to code-spread the information bits. Because of the auto-correlated spreading codes, a plurality of conventionally matched filters operating in parallel are able to resolve multipath signals and substantially obtain the original transmitted signal.

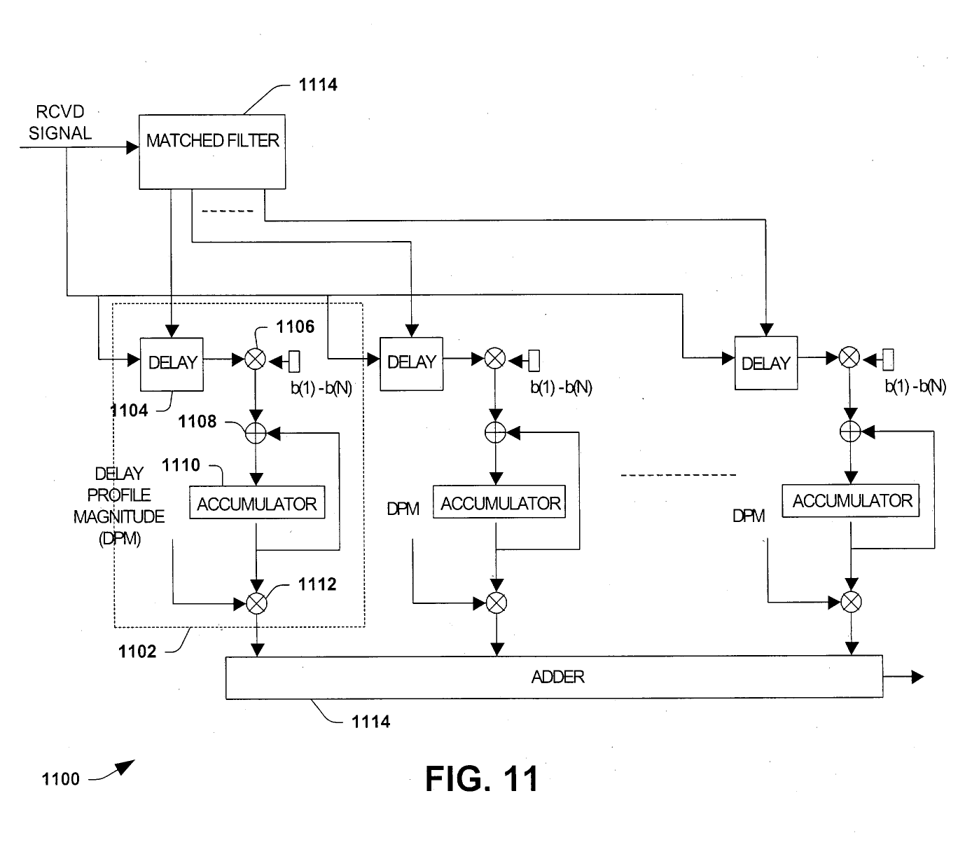

It is appreciated by the inventor of the present invention that Gold codes can be employed to properly resolve multipaths in high data rate communication systems. However, the code-despreading, and thus the measurement of the delay profile, requires 16 separate matched filters working in parallel for the examples above. Furthermore, the matched filter outputs need to be added together synchronously in order to accurately obtain the desired, original signal. After the delay profile has been obtained, however, each resolved path signal needs to be individually de-spread by applying fingers in synchronism with each other. An exemplary, modified CDMA system 1100 that can be used for this is depicted in FIG. 11. The system employs a number of matched filters 1114 for which the number of filters utilized corresponds to the number of codes used in a code group (e.g., 16).

The system 1100 includes a number of units. A unit 1102 includes a delay component 1104, a first multiplier 1106, a second multiplier 1108, an accumulator 1110, and a third multiplier 1112. The delay component 1104 receives the received signal and an output from one the matched filters 1114 and produces a delayed received signal. The first multiplier 1106 multiplies the delayed received signal with de-spreading code to yield a decoded signal. The second multiplier 1108 multiplies the decoded signal with an integrated accumulator output from the accumulator 1110. A magnitude of the matched filter output (delay profile magnitude) is multiplied with the accumulator output by the third multiplier 1112 and added together with outputs from other units by an adder 1116.

Thus, two kinds of information are obtained from the output of the matched filter, a delay of each path signal and its average amplitude. In order to combine the path signal, the path delay of each resolved path is compensated before de-spreading is applied. De-spread results are accumulated over the code-spread interval (32 impulse time interval in the above example) and then its result is multiplied with the magnitude of the average signal amplitude. The multiplied results are then all summed.

It is appreciated by the inventor of the present invention that, for an indoor environment, it is known that the number of significant paths, which are paths within 10 dB from a maximum power path, often exceeds 30 (for non-line-of-sight cases). Thus, 30 or more fingers/units are required to collect the major portion of the signal energy. This requirement together with the number of matched filters that run in parallel (and the accurate timing control) causes a suitable design of a high-performance UWB receiver to be prohibitively complex.

In contrast, the filter 300 depicted in FIG. 3 along with the system 100 of FIG. 1 can feasibly be implemented to provide a high data rate, low power UWB communication system. The analog filter 300 and variations thereof are simpler and avoid the difficulty of timing adjustments and maximum ratio combining and yet is able to achieve the performance depicted in FIG. 10 by the large number of matched filters operating in parallel.

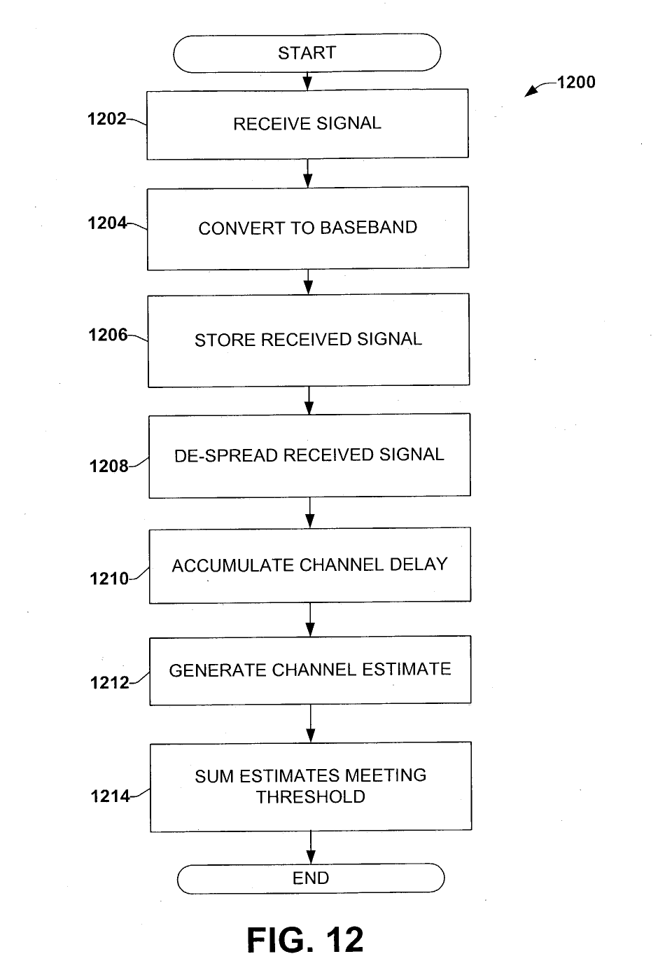

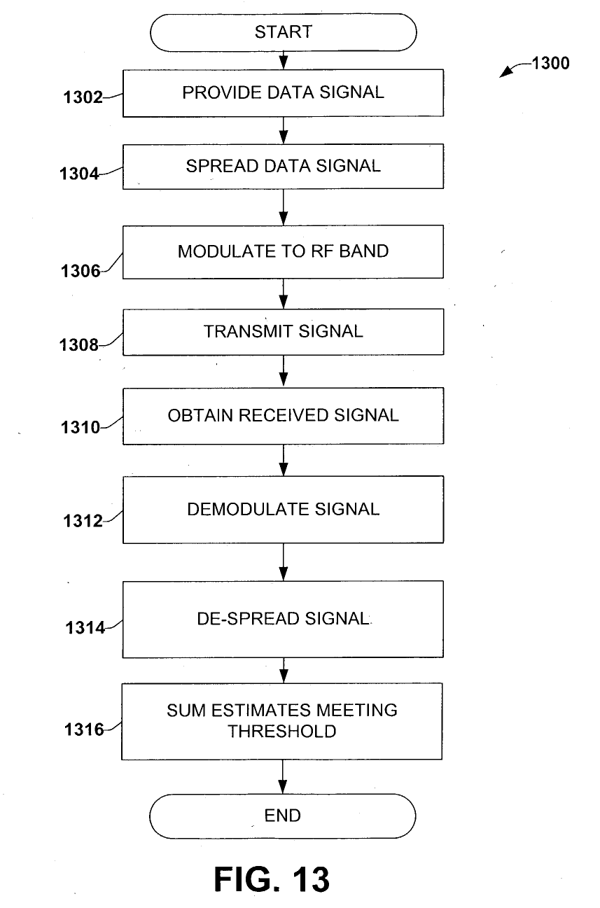

In view of the foregoing structural and functional features described supra, methodologies in accordance with various aspects of the present invention will be better appreciated with reference to FIGS. 1-11. While, for purposes of simplicity of explanation, the methodologies of FIGS. 12-13 are depicted and described as executing serially, it is to be understood and appreciated that the present invention is not limited by the illustrated order, as some aspects could, in accordance with the present invention, occur in different orders and/or concurrently with other aspects from that depicted and described herein. Moreover, not all illustrated features may be required to implement a methodology in accordance with an aspect the present invention.

Turning now to FIG. 12, a flow diagram of a method 1200 of resolving a received signal in accordance with an aspect of the present invention is depicted.

The method 1200 begins at block 1202 where a signal is received by a receiving device (e.g., antenna) and converted from analog to digital. The received signal comprises a transmitted signal and a number of multipath signals and may also include other unwanted or undesired signals. It is appreciated that a line-of-sight signal may not be present in the received signal and that signals of the received signal can be delayed in varied amounts. The received signal is generally at a transmission band or ultra wide band frequency and is converted to a baseband frequency at block 1204. The transmission band is more suitable for transmitting and propagating signals whereas the baseband is more suitable for processing via electronic devices (e.g., circuits, computers, and the like). The transmitted signal comprises information bits spread via an auto-correlated spreading code (e.g., see FIG. 8).

For a plurality of unit components, the received signal is stored temporarily (e.g., a clock cycle at a sufficient sampling frequency) at block 1206. A sample and hold circuit or a shift register can be employed to store the received signal. Continuing, de-spreading code is employed (via multiplying the received signal with) to de-spread the received signal at block 1208. The sample and hold circuit receives the received signal from a previous unit component and transfers the received signal to a next unit component after a clock cycle. A channel delay profile is continuously accumulated regardless of the code group or spreading code boundary, for example, by a leaky integrator at block 1210. The leaky integrator is set to a specific leak-time constant value that corresponds to a delay profile of the communication environment (e.g., indoor delay profile). A channel estimate is generated by the leaky integrator at block 1212. If the channel estimate is below a selected threshold value, the channel estimate is set to zero. Finally, at block 1214, channel estimates from the plurality of unit components are added together to substantially obtain the transmitted signal. Further processing (e.g., higher layers, error correction) can be performed on the transmitted signal.

FIG. 13 is a flow diagram illustrating a method 1300 of communicating via ultra wide band communications in accordance with an aspect of the present invention.

The method 1300 begins at block 1302 wherein a data signal is provided. The data signal can comprise database information, voice data, multimedia data, applications data and the like. The data signal can be generated by converting an analog signal (e.g., video or audio) into the data signal and can be in a compressed and/or encrypted format. The data signal is spread according to spreading code into groups of impulse signals or code groups for each information bit of the data signal at block 1304. The spreading code is auto-correlated and is selected so as to be varied for consecutive code groups, as described supra. The spread signal is converted from a digital signal to an analog signal and then modulated from a baseband frequency to an ultra wide band frequency at block 1306. The ultra wide band frequency is suitable for transmission. The signal is then transmitted in all or a plurality of directions at block 1308.

Continuing at block 1310, a received signal is obtained via an antenna or other suitable receiving device. The received signal is demodulated from the ultra wide band frequency to the baseband frequency at block 1312 and converted from an analog signal to a digital signal. The received signal substantially comprises the data signal along with multipath signals and other unwanted/undesired signals. The received signal is then de-spread via de-spreading code at block 1314. The de-spread signals are utilized to compute channel estimates and then sum only those estimates that meet or exceed a threshold value at block 1316 and thereby produce a received data signal. The analog filter circuit of FIG. 3 can be employed to perform this block 1316. The received data signal is substantially similar to the data signal that was spread and transmitted and can undergo additional processing (e.g., de-compress, decrypt, error correction, and the like).

Although the invention has been shown and described with respect to a certain aspect or various aspects, it is obvious that equivalent alterations and modifications will occur to others skilled in the art upon the reading and understanding of this specification and the annexed drawings. In particular regard to the various functions performed by the above described components (assemblies, devices, circuits, etc.), the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention. In addition, while a particular feature of the invention may have been disclosed with respect to only one of several aspects of the invention, such feature may be combined with one or more other features of the other aspects as may be desired and advantageous for any given or particular application. Furthermore, to the extent that the term “includes” is used in either the detailed description or the claims, such term is intended to be inclusive in a manner similar to the term “comprising.”

What is claimed is:

1. An ultra wide band communication system for low power high data rate operation, the system comprising:
a transmitter station comprising:
a spreading transmitter that spreads an original signal with a spreading code;
a digital to analog converter that converts the original signal from a digital format to an analog format;
a modulator that modulates the original signal from a base-band frequency to an ultra wide band frequency; and
a transceiver that transmits the original signal; and
a receiver station comprising:
an antenna that receives a received signal;
a demodulator that demodulates the received signal from the ultra wide band frequency to the base-band frequency;
an analog to digital converter that converts the received signal from an analog format to a digital format; and
a filter that operates on the received signal to substantially obtain the original signal, the filter comprising:
a number of unit components that respectively comprise:
a de-spreading component that de-spreads the received signal;
a channel estimator that provides a channel estimate according to the received signal and a delay profile; and
a selector that selectively sets the channel estimate to zero on magnitude of an average channel estimate being below a threshold value; and
an adder that sums respective channel estimates from the number of unit components into a data signal, wherein the data signal is substantially similar to the original signal.

2. The system of claim 1, wherein the transmitter station further comprises a symbol encoder that encodes original information into the original signal and the receiver station further comprises a symbol decoder that decodes the data signal into the original information.

3. The system of claim 1, wherein the de-spreading component employs the spreading code.

4. The system of claim 3, wherein the spreading code comprises a plurality of correlated codes such that consecutive information bits employ varied codes.

5. The system of claim 4, wherein the correlated codes are gold codes.

6. The system of claim 1, wherein the delay profile is an indoor delay profile.

7. The system of claim 1, wherein the delay profile includes a maximum path delay of more than 100 nsec.

8. The system of claim 1, wherein the de-spreading component comprises a spread code multiplier that de-spreads the received signal.

9. The system of claim 8, wherein the channel estimator comprises a leaky integrator that receives the received signal from the spread code multiplier and accumulates a channel delay profile and generates the channel estimate.

10. The system of claim 1, wherein the transmitter station is a mobile device.

11. The system of claim 1, wherein the receiver station is a mobile device.

12. The system of claim 1, wherein the original signal has a data rate of more than about 100 Mbps.

13. The system of claim 10, wherein a distance between the transmitter station and the receiver station is less than about 40 meters.

14. An ultra wide band de-spreading filter system comprising:
a number of storage components that store a received signal;
a number of unit components corresponding to the number of storage components that receive the received signal form the number of storage component, wherein the number of unit components combine delay-profile measurements and a de-spreading function to obtain channel estimates, wherein the de-spreading function employs a code group of spreading codes; and
an adder component that sums the channel estimates obtained by the number of unit components and generates a data signal, wherein the data signal is substantially similar to an original data signal.

15. The system of claim 14, wherein the storage component is a sample and hold circuits.

16. The system of claim 14, wherein the unit components respectively comprise:
a spread code multiplier that receives the received signal from one of the storage components and spreading code and generates a product of the received signal and the spreading code;
a leaky integrator that receives the product from the spread code multiplier and accumulates a channel delay profile and generates a channel estimate; and
a selector component that compares the channel estimate with a threshold value and sets the channel estimate to zero on the channel estimate being below the threshold value.

17. The system of claim 16, wherein the leaky integrator has specific leak constant value that corresponds to the threshold value.

18. The system of claim 14, wherein the threshold value is set according to an indoor delay profile having a maximum delay of about 128 nsec.

19. The system of claim 14, wherein the received signal comprises a plurality of multipath signals.

20. The system of claim 14, wherein the spreading code is an auto-correlated code and permits a maximum path delay of less than about 128 nsec for a signal data rate of 100 Mbps and an impulse signal duration of 8 nsec.

21. A method of resolving a received signal in an ultra wide band communication system, the method comprising:
temporarily storing a received signal;
de-spreading the stored received signal with de-spreading code;
accumulating a channel delay profile associated with the stored received signal;
generating a channel estimate associated with the stored received signal; and
on the channel estimate being below a threshold value that corresponds to the channel delay profile, setting the channel estimate to zero.

22. The method of claim 21, further comprising adding the channel estimate with other channel estimates to obtain an original signal.

23. A method of communicating via ultra wide band communications comprising:
spreading a data signal with auto-correlated spreading code, wherein respective information bits are spread into a group of code spread impulse signals;
converting the data signal from a digital format to an analog format;
modulating the data signal to an ultra wide band frequency;
transmitting the data signal;
receiving a signal;
de-modulating the received signal from the ultra wide band frequency to a baseband frequency;
converting the received signal from an analog format to a digital format;
de-spreading the received signal with de-spreading code, the de-spreading code being one of a code group of varied, correlated codes;
generating channel estimates according to the received signal that meet or exceed a threshold delay value; and
generating a received data signal that is substantially similar to the data signal as a function of the generated channel estimates, the threshold delay value, and a delay profile.

24. The method of claim 23, wherein consecutive information bits are spread with a varied code.
